(19) United States
(12) Patent Application Publication
(10) Pub. No.: US 2014/0352704 A1
(43) Pub. Date: Dec. 4, 2014

(54) ORAL APPLIANCE FOR PROTECTING THE TEETH OF A USER

(71) Applicant: Christopher John Farrell, Helensvale (AU)

(72) Inventor: Christopher John Farrell, Helensvale (AU)

(21) Appl. No.: 14/289,057

(22) Filed: May 28, 2014

(30) Foreign Application Priority Data
May 30, 2013 (AU) 2013901935

(51) Int. Cl. A61C 5/14; A63B 71/08

(52) U.S. Cl. CPC A61C 5/14; A63B 71/085; A61C 7/12
USPC 128/862

(57) ABSTRACT

An oral appliance having a base member with a generally U shaped body formed from a thermoplastic elastomer material that is not mouldable at temperatures below about 100° C., the base member having an outer wall portion that defines the outer wall of the appliance and a base extending inwardly from the outer wall that defines a non-mouldable section of the web, the web portion having at least one void formed therein; an inner wall member having a generally U shaped body formed from a material that softens and is mouldable at a temperature below 100° C., that is compatible with the thermoplastic elastomer of the base member, the inner wall member being joined to the base member by chemical adhesion and includes an inner wall portion that defines the inner wall of the appliance and a web portion that projects outwards from the inner wall portion so as to define a user mouldable tooth receiving surface of the web, the web having at least one projection that is complimentary to and received by the at least one void in the base member; and a frame member having a generally U shaped body formed from a thermoplastic material that is rigid and non-mouldable at temperatures below about 100° C. that is encased within the body.

### FIELD

The present disclosure describes an oral appliance for protecting the teeth of a user. This disclosure relates particularly to a mouthguard for protecting the teeth of a user. The appliance can be particularly suitable for being worn by a user wearing orthodontic braces.

### BACKGROUND

The present disclosure specifically describes an oral appliance for protecting the teeth of a user who is wearing braces. However, it will be appreciated that the appliance disclosed herein may have other applications and no limitation is intended thereby.

Oral appliances for protecting the teeth of a user when playing sports or other pursuits where there is a risk of dental or oral injury are well known. Custom mouth guards that are made individually to fit a user's mouth provide the best fit, protection and comfort. However, they are prohibitively expensive for most users.

For this reason, mouthguards known as “boil and bite” mouthguards have become the most widely used form of mouthguard available today. The boil and bite mouthguards are typically formed from ethylene vinyl acetate (EVA) that softens at about the temperature of boiling water. In order to fit the mouthguards, they are placed in hot water for a period of time, cooled and then placed in the mouth of a user who uses their tongue and biting pressure to fit the mouthguard around the teeth.

A recognized disadvantage of the boil and bite mouthguards is that during the moulding process, as the user bites down on the softened material, the thickness of the mouthguard is reduced, thereby reducing the shock dissipating function of the mouthguard.

A desirable advantage of the boil and bite mouthguards is that the moulding process allows the guard to fit closely about the teeth which holds the guard in place during use. Without such moulding the guard can easily become dislodged and must be held in place by the user keeping their teeth together. This creates difficulties with breathing and speaking.

Many people who need to wear a mouthguard during sporting activities wear orthodontic braces. They also need to protect their inter-oral structures such as gums and buccal mucosa from injury due to the bands and wires of the orthodontic structures. However, persons with braces are unable to use the conventional boil and bite mouthguards as the softened EVA will mould around and stick to the braces.

In order to address this problem, it is known to provide mouthguards formed from a soft material such as silicon. The silicon shapes to the users' teeth when fitted into the mouth. It does not have a memory and reforms every time it is placed into the mouth. The lack of memory has advantages for brace wearers as it readily adjusts for movement of the teeth as a result of the orthodontic treatment and/or adjustment of the braces by the dentist. Conventional mouthguards that have been moulded to the original position of the teeth can actually act to force the teeth back into the original position.

A disadvantage of the silicone mouthguards is that as they are relatively soft they offer only limited protection to the teeth. If a blow strikes the front of the mouthguard it tends to deform and the front teeth can bear the brunt of the blow.

It is known to provide rigidity to boil and bite mouthguards by providing a core formed from a material that is more rigid than EVA. Such an appliance is described in the present inventor's earlier U.S. Pat. No. 6,637,436. An essential part of this earlier invention was the discovery of the compatibility of EVA with a polyethylene (PE) core that allows the mouthguard to be formed and used without delaminating. There is no such compatibility between PE and silicone, thereby preventing such a solution to be used to improve the rigidity of the silicone brace mouthguards.

Another disadvantage of the silicon mouthguards is that as they are not moulded and fitted to the teeth, they must be held in place by keeping the mouth closed.

Another appliance that has been proposed for use by users with braces is that described in U.S. Pat. No. 7,530,355. The mouthguard is a conventional U shape with outer and inner walls with a web therebetween. The mouthguard has a mouldable EVA base portion that defines the web and an inner wall and a non-softenable upper portion made from PVC defining the outer wall.

The mouthguard can be moulded in a similar manner as a conventional boil and bite mouthguard and during moulding, the non-softenable PVC contacts the braces and the mouldable EVA portion can be moulded to the lingual surface and crown of the teeth.

As mentioned above, during the course of treatment with braces, the teeth are realigned. Consequently, wearing a mouthguard that has been customised to a previous tooth position has an adverse effect on the treatment process. It is possible to re-mould a both a boil and bite mouthguard and a mouthguard as described in U.S. Pat. No. 7,530,355. However such remoulding can cause significant thinning out n the occlusal area of the mouthguard, thereby reducing the effectiveness of the mouthguard.

There is therefore a need in the industry to provide an alternative oral appliance for use by persons' with braces.

### SUMMARY

According to a first aspect, there is provided an oral appliance having a generally U shaped body, the appliance comprising an outer wall, an inner wall and a web interconnecting the inner and outer walls so as to define a channel for receiving an upper or lower arch of a user, wherein the appliance comprises:
a base member formed from a material that does not substantially soften and is not mouldable at temperatures below about 100° C., the base member having an outer wall portion that defines the outer wall of the appliance and a web portion extending inwardly from the outer wall that defines a non-mouldable section of the web;
an inner wall member formed from a material that softens and is mouldable at a temperature below 100° C. that is joined to the base member and includes an inner wall portion that defines the inner wall of the appliance and a web portion that projects outwards from the inner wall portion so as to define a user mouldable arch receiving surface of the web; and
a frame member that is encased within the body for conferring a suitable degree of structural stiffness to the appliance.

The appliance has a U shaped body that has a channel for receiving the upper or lower arch of a user. Suitably, the appliance receives the teeth of the upper or maxillary arch, as per the most common form of mouthguard.

The appliance has a front portion that receives the incisors and canine teeth and arms that extend into the occlusal plane and that receive the molars and premolars. The web extends between the inner and outer walls and has an inner edge adjacent the inner wall and an outer edge that is adjacent the outer wall.

In some orthodontic treatments, braces may be fitted to the lower teeth. In this case, the appliance may be adapted to receive the lower or mandibular arch.

In a further embodiment, the appliance may receive both the maxillary arch and mandibular arch.

The appliance has a base member that is formed from a material that does not soften at temperatures above about 100° C. This means that the base member is not deformable when the appliance is placed in boiling or hot water.

The base member is suitably formed from a thermoplastic elastomer or rubber material that allows the base to be moulded using conventional thermoplastic moulding techniques, and when moulded has rubber like or elastomeric properties. Thermoplastic rubbers include thermoplastic styrene, soft polyurethanes, polyolefin based materials such as Santoprene and styrene based rubbers. Particularly preferred materials are the polystyrene butadiene block copolymers (SBS) or polystyrene isoprene block copolymers.

The glass transition temperature (Tg) of the polybutadiene blocks is typically −90° C. and Tg of the polystyrene blocks is +100° C. So, at any temperature between about −90° C. and +100° C. SBS will act as a physically crosslinked elastomer. If SBS polymers are heated substantially above the Tg of the styrene-derived blocks, that is, above about 100 C, like 170 C the physical cross-links change from rigid glassy regions to flowable melt regions and the entire material flows and therefore can be cast, molded, or extruded into any desired form. On cooling, this new form resumes its elastomeric character.

The base member has an outer wall portion that defines the outer wall of the appliance. The outer wall portion suitably has an outwardly facing facial surface and an inner channel surface that contacts the teeth.

The outer wall portion is suitably resiliently flexible so as to provide a degree of comfort and cushioning for cushioning the appliance against the teeth and gums of the user when the appliance is being worn.

The inner channel surface of the outer wall portion suitably has a brace channel extending around the full length thereof. In use, the channel can receive the braces of a user such that the inner channel surface does not unduly press against the braces.

In the embodiment where the apparatus is fitted to the maxillary arch, the frontal portion of the outer wall may have a section that extends below the web. Suitably this section has at last one breathing hole extending therethrough.

In the embodiment where the appliance receives both the upper and lower arches, the outer wall may extend below the web so that it projects over the lower teeth.

The base member has a U shaped base extending inwardly from the outer wall portion that forms a non user mouldable part of the web of the appliance. In other words, when the appliance is placed in water at high temperatures the base member does not soften and is not subject to deformation during the normal boil and bite moulding procedure.

The appliance has an inner wall member that has an inner wall portion that defines the inner wall of the appliance. The inner wall member is formed from a material that softens at below about 100° C., suitably between about 70° C. and about 95° C.

Suitably, the materials of the base member and inner wall member are compatible which means that inner wall member may be overmoulded onto the base member such that the two parts are joined by chemical adhesion rather than mechanical interlocking.

An especially preferred material is EVA that is widely used in boil and bite mouthguards. The present inventor has surprisingly and unexpectedly discovered that EVA is compatible with SBS.

The inner wall member has a user mouldable web portion that extends away from the inner wall portion and forms the teeth contacting surface of the web of the appliance.

Suitably the user mouldable web portion extends across the full width of the web of the appliance so that it has an outer terminal section that abuts the inner channel surface of the outer wall.

Suitably the web portion terminates in an outer lip that forms part of the tooth channel surface of the outer wall. In the preferred embodiment where the inner surface of the outer wall has an inwardly facing brace channel, the edge of the lip forms the lower edge of the brace receiving channel. In this way, the lip of the inner wall member may be user moulded around the tips of the facial surfaces of the teeth.

In use, the inner wall member is able to be heated in boiling water and moulded in situ as per conventional EVA mouthguards such that the inner wall portion and web are moulded to the shape of the lingual surfaces and suitably, also the tips of the facial surfaces of the teeth. As the outer wall portion of the base member does not soften and is not mouldable at these temperatures the appliance does not interfere with any braces that are being worn.

The non user mouldable base member and the mouldable inner wall member are joined together, suitably at least along the respective web portions.

It will be appreciated that the surface area for joining the respective web portions together can extend across the full width of web, thereby maximising the contact area. The contact area can be further increased by forming the base member to have one or more voids in the web portion, that can receive complimentary projecting portions of the inner wall member.

A further advantage of filling one or more voids in the U shaped base of the base member with the user mouldable inner wall member material is that the degree of mouldability, compression and physical properties can be tailored and/or optimised. For example, a void may be located in that part of the base that locates in the occlusal plane. In use, this area is subject to greater compression that the rest of the appliance as a result of the compressive force exerted by the molars. Additional cushioning in the occlusal area is desirable to protect the teeth.

A known disadvantage with boil and bite mouthguards is that they are subject to a decrease in thickness in the occlusal area during moulding which decreases their effectiveness. Still further, the thickness can be decreased as the mouthguard is remoulded. This is of particular concern for users who are undergoing orthodontic treatment such as braces where the teeth are being moved. In this case, it is necessary to remould a mouthguard to accommodate such movement and also after the orthodontist has made any adjustments to the mouthguard.

As the mouldable occlusal cushion is located within a void of non user mouldable material, the non user mouldable material prevents or reduces the reduction in thickness of the mouldable material in the occlusal cushioning area.

The web of the appliance thus is formed from the user mouldable U shaped web of the inner wall member joined to the non user mouldable base of the base member. The end of the user mouldable U shaped web of the inner wall member has a first thickness and the end of the non user mouldable U shaped base has a second thickness.

Suitably, the first thickness is equal to or less than the second thickness. This may serve to minimise or reduce the thinning at the ends of the arms of an oral appliance during user moulding. As the base is non user mouldable, the second thickness remains constant during user moulding.

Suitably, the ratio of the first thickness to the second thickness is between 1:1 and 1:4, suitably between 1:2 and 1:3.

The appliance further includes a frame member that is encased within the appliance body for conferring a suitable degree of structural stiffness to the appliance. The material of the frame is suitably a thermoplastic selected from the group consisting of polyamide, polyethylene, polypropylene, polyurethane, polycarbonate or santoprene.

The frame member suitably has a U shaped outer rail with arms that are encased in and towards the outer edge of the web of the appliance. In this way, the frame member may provide a degree of rigidity to the appliance and also can dissipate forces received by a frontal blow and to transmit this force to the rear of the appliance where the force can be absorbed by the molars.

The U shaped outer rail suitably has a width with a portion that is encased in the outer wall of the appliance. This may optimise the load dissipation.

In the embodiment where the inner wall member has an outer lip that forms part of the channel surface of the outer wall, the outer rail may locate between the outer lip and the outer wall.

Suitably, the frame member has a second inner rail that is located around the inner edge of the web. In this case, it is preferred that the frame member includes spaced cross members extending between the respective rails. The cross members are encased in the web.

In the embodiment where the base includes voids in the U shaped base as discussed above, the cross members of the frame member are dimensioned to be received on land portions of the base between the voids.

The frame and base members are generally injection moulded as a separate piece. After the base member has been moulded, the frame and the base member are placed in a second mould in which the inner wall member is injection moulded. The frame is kept in place between the base member and the inner wall member.

### BRIEF DESCRIPTION OF THE FIGURES

FIG. 1 is a front perspective view of a preferred appliance of the present invention in the form of a mouthguard;

FIG. 2 is a perspective view of the inner wall member of the mouthguard shown in FIG. 1;

FIG. 3 is a perspective view of the frame member of the mouthguard shown in FIG. 1;

FIG. 4 is a perspective view of the base member of the mouthguard shown in FIG. 1;

FIG. 5 is rear perspective view of the mouthguard shown in FIG. 1;

FIG. 6 is a rear view of the mouthguard shown in FIG. 1;

FIG. 7 is a bottom plan view of the mouthguard shown in FIG. 1;

FIG. 8 is a top plan view of the mouthguard shown in FIG. 1;

FIG. 9 is a front view of the mouthguard shown in FIG. 1;

FIG. 10 is a left side view of the mouthguard shown in FIG. 1;

FIG. 11 is a cross section of the mouthguard shown in FIG. 1;

FIG. 12 is a right side view showing schematically the web portion of the inner wall member;

FIG. 13 is a bottom plan view showing schematically the web portion of the base member;

FIG. 14 is a front perspective view of a further preferred mouthguard of the present invention;

FIG. 15 is a perspective view of the inner wall member of the mouthguard shown in FIG. 14;

FIG. 16 is a perspective view of the frame member of the mouthguard shown in FIG. 14;

FIG. 17 is a perspective view of the base member of the mouthguard shown in FIG. 14;

FIG. 18 is rear perspective view of the mouthguard shown in FIG. 14;

FIG. 19 is a rear view of the mouthguard shown in FIG. 14;

FIG. 20 is a bottom plan view of the mouthguard shown in FIG. 14;

FIG. 21 is a top plan view of the mouthguard shown in FIG. 14;

FIG. 22 is a front view of the mouthguard shown in FIG. 14;

FIG. 23 is a left side view of the mouthguard shown in FIG. 14 and

FIG. 24 is a cross section of the mouthguard shown in FIG. 14.

### DETAILED DESCRIPTION OF THE FIGURES

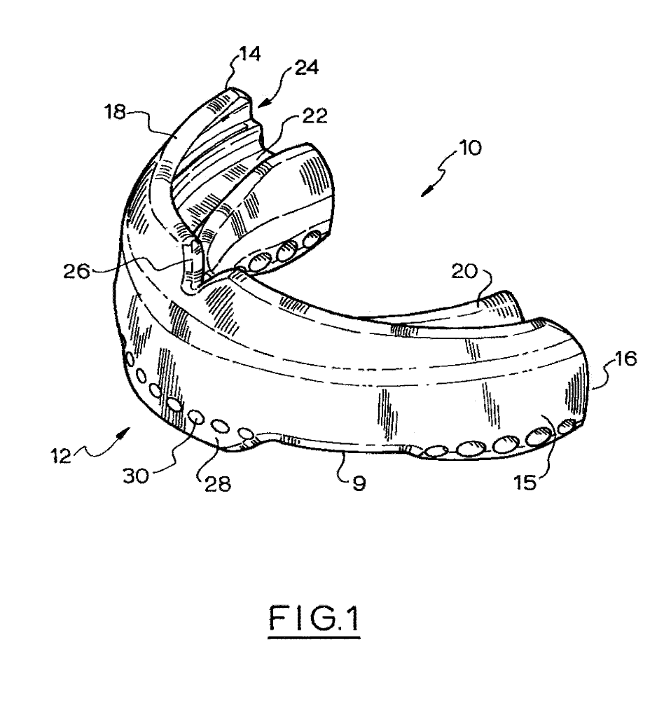

FIG. 1 is a perspective view of a preferred oral appliance 10 of the present invention in the form of a mouthguard. The mouthguard 10 has a U shaped body with a front portion 12 and two arms 14, 16.

The mouthguard 10 has an outer wall 18, an inner wall 20 connected by a web 22 so as to form an upper arch receiving channel 24 for receiving the teeth of the upper arch. The arms extend into the occlusal plane of a user and receive the molars and premolars. The front portion 12 receives the incisors and canine teeth of a user. A thickened occlusal cushioning portion 15 is located towards the end of each arm 14, 16.

At the base of the guard 10 between the occlusal portion 15 and the front portion 12 is a section of reduced thickness 9. In use, this allows the passage of air so as to assist in breathing.

The front portion 12 has a notch or cut out 26 that has the function of permitting inward or outward adjustment of the arms 14, 16 of the mouthguard without causing distortion. This allows the mouthguard to be fitted to different arch widths.

The front of the outer wall 18 has a section 28 that extends below the web 22 that has a series of breathing holes 30.

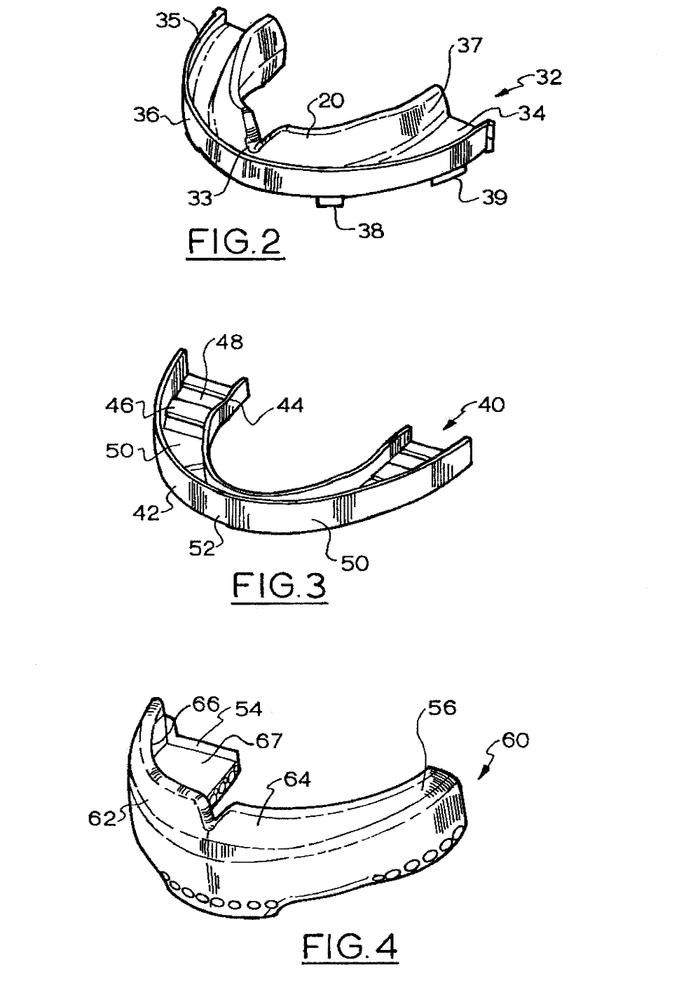

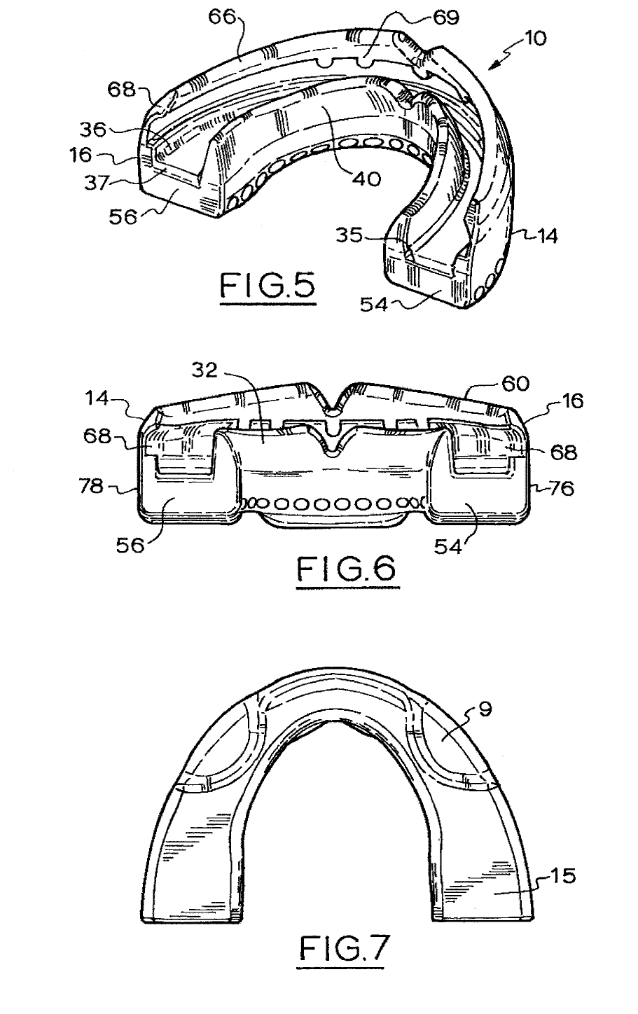

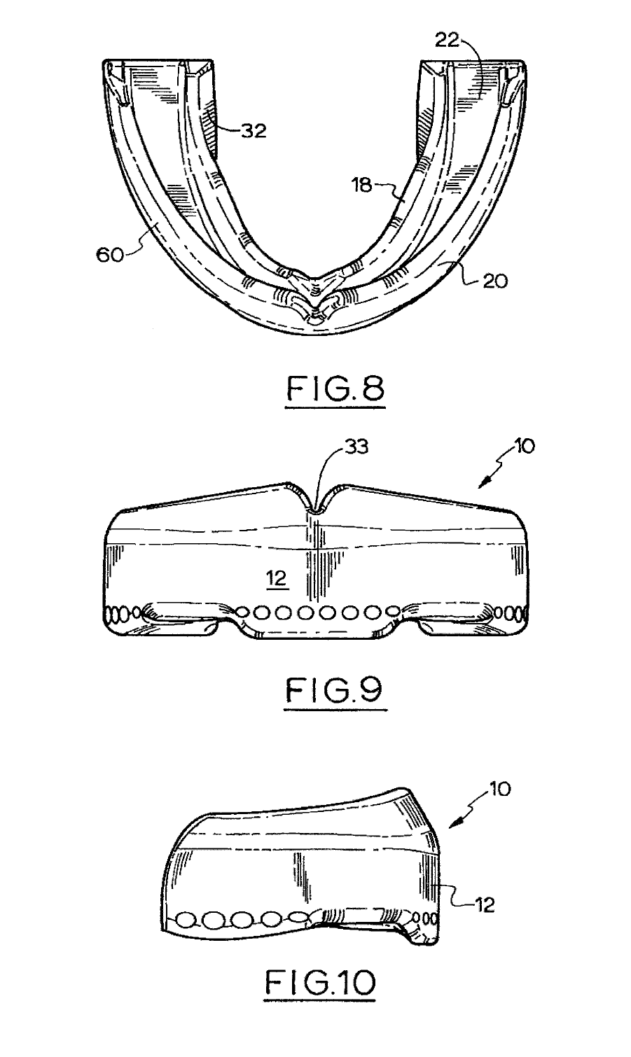

The appliance 10 is a three part structure formed from a base member 60, a frame 40 member and an inner wall member 32. These are shown separately in FIGS. 2, 3 and 4.

FIG. 2 shows a perspective view of the inner wall member 32. The inner wall member 32 is U shaped with arms 35, 37, an inner wall portion that defines the inner wall 20. The inner wall member 32 is formed from EVA. The inner wall member 32 has a notch 33 corresponding to the notch 26 in the outer wall 18 and performs the same function.

The inner wall member 32 has a web 34 that extends outwardly from the inner wall 20 and terminates in an outer lip 36.

The underside of the inner wall member 32 has two opposed pairs of pads 38, 39. Pads 39 are located in the occlusal cushioning portion 15 of the appliance 10 and pads 38 are located towards the front portion 12 of the oral appliance 10. The front pads 38 are located in that part of the appliance that receives the canine teeth.

FIG. 3 shows the frame member 40. The frame member 40 is also U shaped and has a front portion 52 and arms 41, 43. The frame member 40 includes a U shaped outer rail 42 and a U shaped inner rail 44. The rails 44, 46 are connected by spaced cross members 46 extending therebetween. The cross members 46 define two pairs of opposed spaces 48, 50. Spaces 48 are located towards the ends of the arms and spaced 50 are located towards the front portion 52. The spaces 48 that are towards the ends of the arms are dimensioned to correspond with to correspond to and receive the pads 39 and the spaces 50 are dimensioned to correspond to and receive pads 38.

The frame member 40 is formed from polycarbonate that has a degree of rigidity but a suitable level of flexing so that it can conform to different arch widths. Polycarbonate has a glass transition temperature of about 147° C. which means that it does not soften during either the injection moulding process of the inner wall member (discussed below) or the user-moulding process. The frame member 40 therefore provides a degree of rigidity to the mouthguard when it is user moulded.

The front portion 52 of the outer rail 46 of the frame member 40 is able to absorb impact from a frontally placed blow. The frame member 40 is able to dissipate the force of the blow to the rear of the appliance 10 where the force of a blow can be absorbed by the molars.

FIG. 4 shows the base member 60. The base member 60 is U shaped with an outer wall portion 62 that defines the outer wall 18 of the oral appliance 10, arms 54, 56 and a base 67 extending inwardly from the outer wall portion 62. The outer wall portion 62 has an outer facial surface 64 and an inner surface 66.

The base member 60 is formed from a thermoplastic rubber that does not soften and is not mouldable at temperatures below about 100° C. The rubber is mouldable at high temperatures which enable the inner wall member 60 to be injection moulded by standard moulding techniques. However, at temperatures below the softening point, the material has elastomeric and/or rubber properties. The outer wall portion has a degree of softness and flexibility so that it is comfortable in the mouth and against the lingual and buccal surfaces.

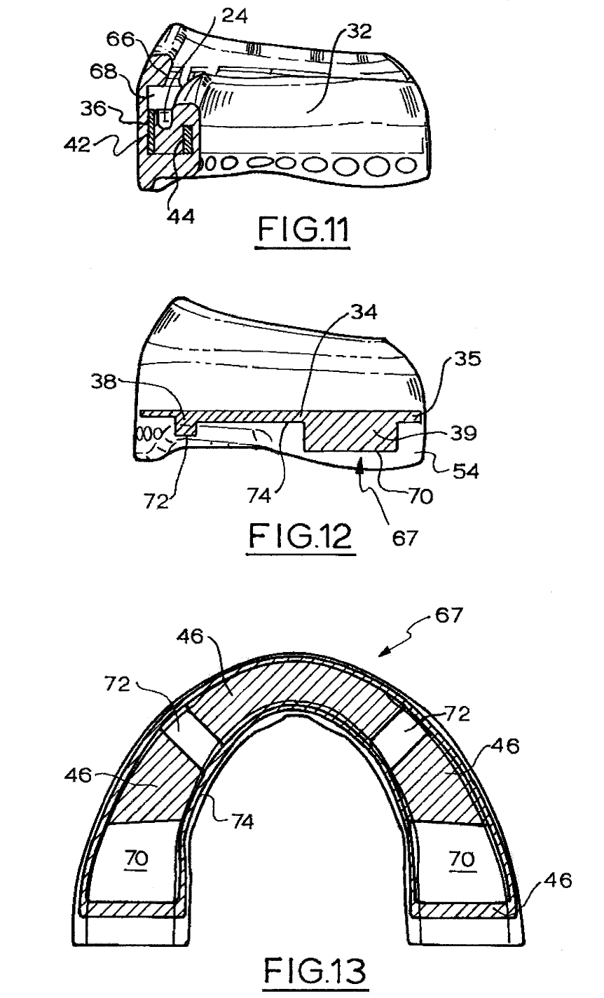

The base 67 of the base member 60 is moulded with opposed pairs of voids 70, 72 formed therein (see FIG. 12). The voids 70, 72 are separated by lands 74. Voids 70 are located in the occlusal cushioning portion 15 and voids 72 are located in that part of the appliance that receives the canines.

During manufacture of the oral appliance 10, the base member 60 and frame member 40 are separately injection moulded. The frame member 40 is then placed on the base 67 of the base member 60. The cross members 46 of the frame member 32 are dimensioned to be received on the lands 74 of the base 67.

The base member 60 and frame member 40 are then placed in a die where the inner wall member 32 is injection moulded. During the injection moulding process, the voids 70, 72 are filled with the EVA of the inner wall member 32 so as to form the pads 39, 38 that fill the voids 70, 72. This may be seen schematically in FIG. 12.

The frame member 40 is thus encased within the oral appliance 10 and is located between the inner wall member 32 and the base member 60. The outer rail 42 of the frame member 40 lies between the outer lip 36 of the inner wall member 32 and part of the inner tooth contact surface 66 that is below the braces channel 68.

The EVA of the inner wall member 32 and the thermoplastics rubber of the base member 60 have excellent compatibility which means that the two members can adhere readily and firmly to each other and can resist delamination. As the web 34 of the inner wall member 32 extends across the base 67 of the outer wall member 60, the area of contact is maximised. The web of the inner wall member 34 joined to the base 67 of the base member 60 forms the web 22 of the oral appliance 10.

FIGS. 5 and 6 show the rear views of the oral appliance 10. These views show that the braces channel 68 that extends along the length of the inner surface 66. In use the braces channel 68 receives any braces worn by a user. The upper edge of the outer lip 36 of the inner wall member 32 defines the lower edge of the braces channel 68.

It may be appreciated that outer lip 36 is user mouldable about the lower parts of the teeth. This can assist in retaining the oral appliance 10 in position such that the user is able to open the mouth without the appliance dislodging or becoming loose.

The braces channel 68 has five lip bumpers 69 around the front of the U. These bumpers 69 provide further protection to the lips from being lacerated or otherwise injured by the braces in the event of a blow to the face.

FIGS. 5 and 6 shows the ends 76, 78 of the arms 14, 16 of the oral appliance. The ends of the arms 54, 56 of the base member 60 are relatively thick compared with the ends of the arms 35, 37 of the web 34 of the inner wall member 32. However, the occlusal pad 39 of the inner wall member substantially thickens the depth of the inner wall member 32 in the occlusal region so as to allow a thicker amount of mouldable EVA around the molars.

FIG. 12 schematically shows the side view of the oral appliance 12 and the relative thickness of the web 34 of the inner wall member that is joined to the base 67 of the base member 60 so as to form the web 22 of the oral appliance 10. It may be seen that the thickness of the base 67 is greater than the thickness of the user mouldable web 34 of the inner wall member toward the ends of the arms of the oral appliance.

As the base 67 of the outer wall member 60 is not deformable at user moulding temperatures, the overall thickness of the end of the arms 14, 16 is not considerably reduced or thinned during user moulding.

Undue compression or thinning around the occlusal region caused by compression between the molars is a known disadvantage of conventional boil and bite mouthguards. If such a mouthguard is remoulded, additional thinning in this section occurs. It will be appreciated that such thinning adversely affects the shock absorbing performance of the mouthguards. Still further, many users tend to chew on the ends of the guards, thereby further comprising performance.

However, with the oral appliance as illustrated, the base and sides of the EVA pads 38, 39 are essentially surrounded by a non user mouldable material which serves to maintain the dimensions of width and depth during remoulding. This is serves to prevent or minimise thinning of the appliance in the occlusal region. This is particularly advantageous when numerous refittings of the mouthguard are to allow for repositioning of the teeth during the orthodontic treatment. The mouthguard may be heated and remoulded a number of times during its life, without significant loss of performance.

Undue thinning at the ends of conventional mouthguards is also a disadvantage of conventional mouthguards. This has been further addressed by providing the ends of the user mouldable web 34 of the inner wall member having a first thickness that is less than the base 67 of the base member 60.

It will be appreciated that the presence of the pads 38, 39 that extend into voids 70, 72 provide a number of working advantages to the oral appliance 10. The pads 38, 39 increase the contact surface area between the inner wall member 32 and the base member 62, thereby optimizing chemical adhesion and resistance to delamination, the pads 38, 39 interlock with the cross members 46 of the frame member 40 so as to secure the frame member in place. Further, the pads provide thickened areas of the softer material so as to optimise cushioning in the desired areas. Still further, as the pads are restrained from thinning out during user moulding as they are contained within the voids of the base member 60.

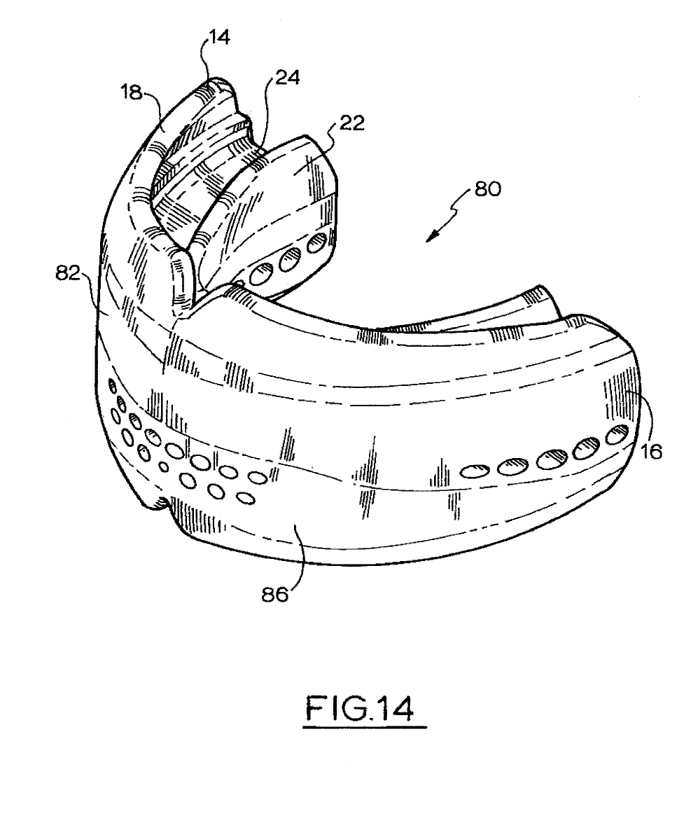

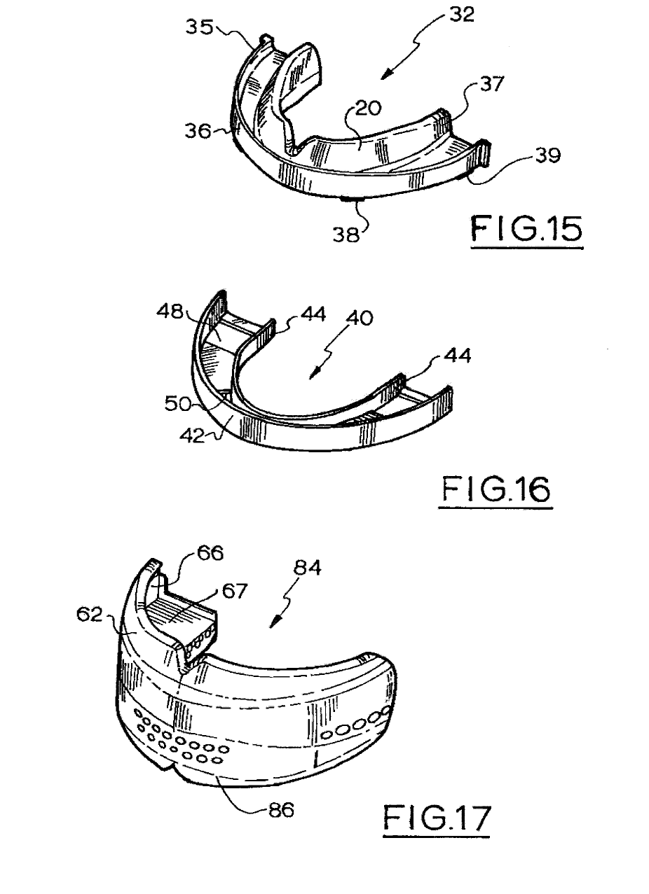

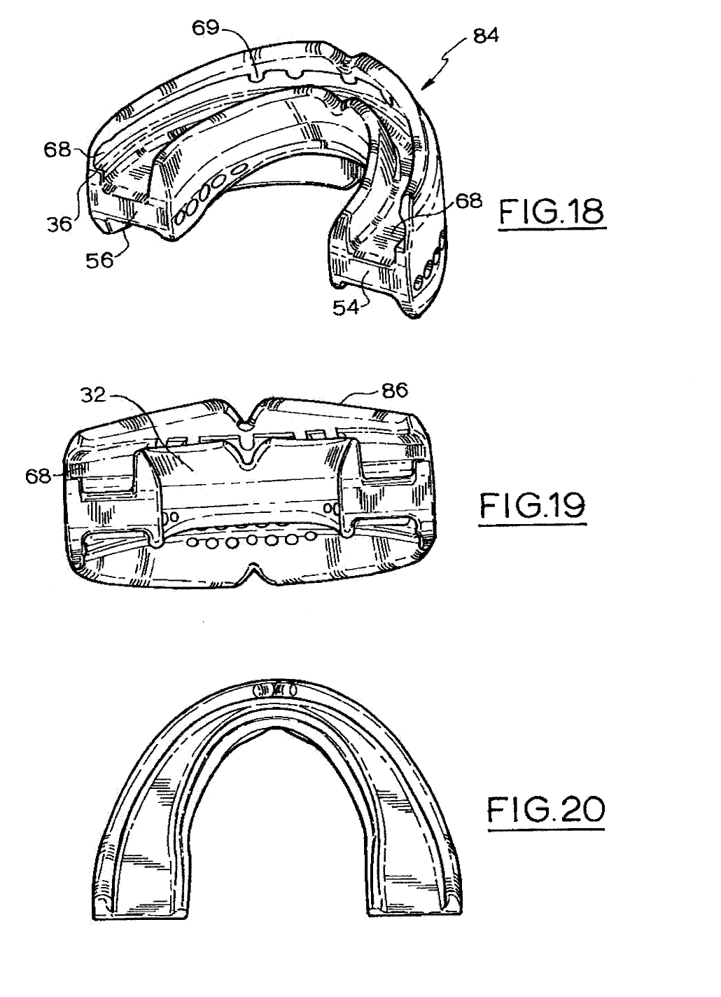

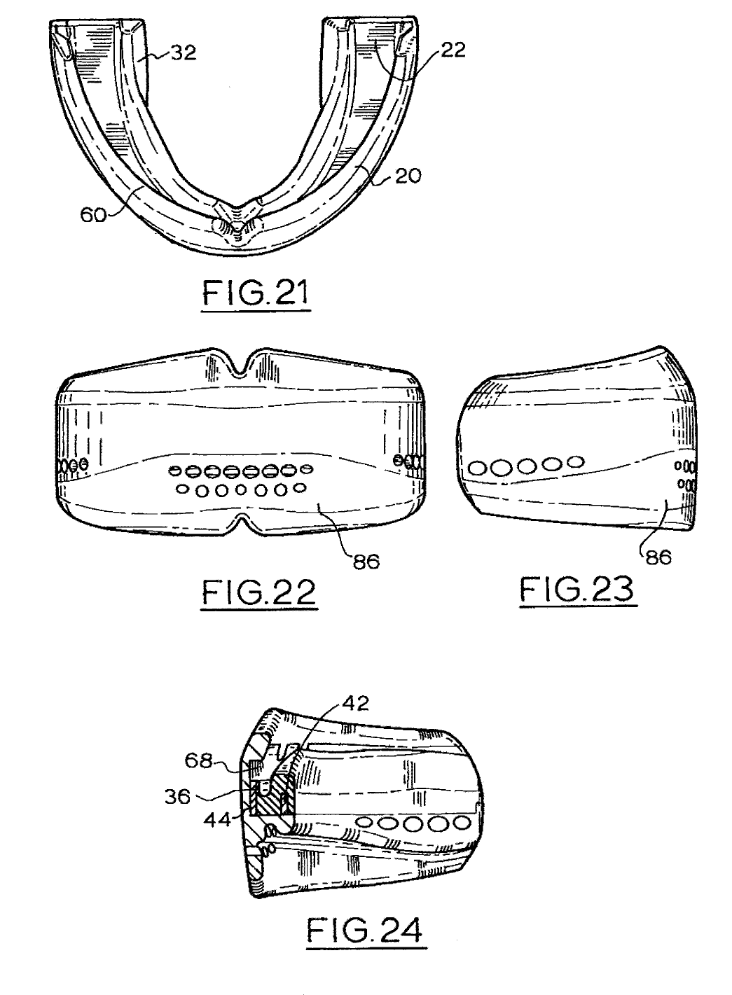

FIGS. 14 to 24 show a further preferred appliance 80 of the present invention that is a double mouthguard in that it defines upper and lower teeth receiving channels for receiving the upper and lower arches. The same reference numerals will be used to describe the same features.

The inner wall member 32 and the frame member 40 are essentially the same as for the single upper arch guard 10. However, the outer wall portion 82 of the base member 84 extends below the web 22 to form a lower outer wall 86 that substantially covers the lower teeth.

It will be appreciated that the present invention provides numerous advantages and alternatives to the conventional silicon mouthguard for braces and also conventional boil and bite mouthguards. First, the appliance of the present invention is able to be customised by moulding without adversely affecting or sticking to the braces. The appliance is constructed in such a manner that the integrity of the thickness of the occlusal cushion may be substantially retained during a number of moulding and remoulding cycles.

It will be appreciated that various changes and modifications may be made to the invention as described and claimed herein without departing of the spirit and scope thereof.

1. An oral appliance having a generally U shaped body with a front portion and two arms extending therefrom, the appliance comprising an outer wall, an inner wall and a web interconnecting the inner and outer walls so as to define a channel for receiving an upper or lower arch of a user such that the front portion receives the incisors and canine teeth of a user and the arms extend into the occlusal plane and receive the molars and premolars;
wherein the appliance comprises;
a base member having a generally U shaped body formed from a thermoplastic elastomer material that is not mouldable at temperatures below about 100° C., the base member having an outer wall portion that defines the outer wall of the appliance and a base extending inwardly from the outer wall that defines a non-mouldable section of the web, the web portion having at least one void formed therein;
an inner wall member having a generally U shaped body formed from a material that softens and is mouldable at a temperature below 100° C., that is compatible with the thermoplastic elastomer of the base member, the inner wall member being joined to the base member by chemical adhesion and includes an inner wall portion that defines the inner wall of the appliance and a web portion that projects outwards from the inner wall portion so as to define a user mouldable tooth receiving surface of the web, the web having at least one projection that is complimentary to and received by the at least one void in the base member; and
a frame member having a generally U shaped body formed from a thermoplastic material that is rigid and non-mouldable at temperatures below about 100° C. that is encased within the body.

2. The oral appliance of claim 1, wherein the base member includes a void on that part of each arm that extends into the occlusal plane and the complimentary projections of the inner wall member form occlusal cushions.

3. The oral appliance of claim 2, wherein the base member includes two further voids in that part of the front portion that receives the canine teeth.

4. The oral appliance of claim 1, wherein the outer wall has an outwardly facing facial surface and an inner surface and the inner surface has a brace receiving channel.

5. The oral appliance of claim 4, wherein the web portion of the inner wall member extends across the full width of the web of the appliance so that the web has an outer terminal section that abuts the inner surface of the outer wall.

6. The oral appliance of claim 5, wherein, the outer terminal section forms an outer user mouldable lip that extends along the inner surface of the outer wall below the brace channel.

7. The oral appliance of claim 6, wherein the frame member includes an outer U shaped rail that is encased between the inner surface of the outer wall and the outer lip.

8. The oral appliance of claim 7, wherein the frame member includes a second inner U shaped rail that is encased within the inner wall.

9. The oral appliance of claim 8, wherein the frame member includes with cross members extending between the inner and outer rails so as to define spaces between the cross members that are complimentary to the voids in the base member.

10. The oral appliance of claim 1 that receives the teeth of the upper arch.

11. The oral appliance of claim 1 that receives the teeth of the upper and lower arches.

12. The oral appliance of claim 1, wherein the material of the inner wall member is EVA.

13. The oral appliance of claim 1, wherein the material of the base member is a thermoplastic polystyrene butadiene block copolymer.

14. The oral appliance of claim 1, wherein the material of the frame member is selected form the group consisting of polyamide, polyethylene, polypropylene, polyurethane, polycarbonate or santoprene.

15. An oral appliance having a generally U shaped body, the appliance comprising an outer wall, an inner wall and a web interconnecting the inner and outer walls so as to define a U shaped channel for receiving an upper or lower arch of a user, wherein the appliance comprises:
a generally U shaped base member formed from a material that does not substantially soften and is not mouldable at temperatures below about 100° C., the base member having an outer wall portion that defines the outer wall of the appliance and a generally U shaped base extending inwardly from the outer wall that defines a non-mouldable base section of the web of the appliance;
a generally U shaped inner wall member formed from a material that softens and is mouldable at a temperature below 100° C. that is joined to the base member and includes an inner wall portion that defines the inner wall of the appliance and a generally U shaped web portion that projects outwards from the inner wall portion so as to define a user mouldable arch receiving surface of the web of the appliance, and
a generally U shaped frame member that is encased within the body that is rigid and non-mouldable at temperatures below about 100° C.

16. The oral appliance of claim 15, wherein the outer wall member has an outwardly facing facial surface and an inner channel surface and the inner channel surface has a brace receiving channel extending around the full length thereof.

17. The oral appliance claim 15, wherein the material of the inner wall member is EVA, the material of the outer wall member is a thermoplastics elastomer and the material of the frame member is polycarbonate.

18. The oral appliance of claim 15, wherein the web of the appliance has two arms with arm ends and the ends have a section of the user mouldable web portion of the inner wall member joined to non user mouldable base of the base member, the user mouldable U shaped web of the inner wall member has a first thickness and the end of the non user mouldable U shaped base has a second thickness, wherein the first thickness is equal to or less than that of the second thickness.

19. The oral appliance of claim 18, wherein the ratio of the first thickness to the second thickness is between 1:1 and 1:4.

20. The oral appliance of claim 19, wherein the ratio is between 1:2 and 1:3.
